(19) United States
(12) Patent Application Publication
(10) Pub. No.: US 2006/0288067 A1
(43) Pub. Date: Dec. 21, 2006

(54) Reduced complexity recursive least square lattice structure adaptive filter by means of approximating the forward error prediction squares using the backward error prediction squares

(75) Inventors: David L. Barron, Scottsdale, AZ (US); James B. Piket, Gilbert, AZ (US); Christopher W. Springfield, Chandler, AZ (US)

Correspondence Address: BRINKS HOFER GILSON & LIONE, P.O. BOX 10395, CHICAGO, IL, 60610, US

(73) Assignee: Motorola, Inc.

(21) Appl. No.: 11/399,989

(22) Filed: Apr. 7, 2006

Related U.S. Application Data
(60) Provisional application No. 60/692,345, filed on Jun. 20, 2005.
(60) Provisional application No. 60/692,236, filed on Jun. 20, 2005.
(60) Provisional application No. 60/692,347, filed on Jun. 20, 2005.

(51) Int. Cl. G06F 17/10

(52) U.S. Cl. 708/323

(57) ABSTRACT

A method for reducing a computational complexity of an m-stage adaptive filter is provided by determining a weighted sum of backward prediction error squares for stage m at time n, determining a conversion factor for stage m at time n, inverting the weighted sum of backward prediction error squares, and approximating a weighted sum of forward prediction error squares by combining the inverted weighted sum of backward prediction error squares with the conversion factor.

### RELATED APPLICATIONS

This application claims the benefit of U.S. Provisional Application No. 60/692,345, filed Jun. 20, 2005, U.S. Provisional Application No. 60/692,236, filed Jun. 20, 2005, and U.S. Provisional Application No. 60/692,347, filed Jun. 20, 2005, all of which are incorporated herein by reference.

### FIELD OF THE INVENTION

The present invention relates in general to adaptive filters and, more particularly, to a reduced complexity recursive least square lattice structure adaptive filter.

### BACKGROUND

Adaptive filters are found in a wide range of applications and come in a wide variety of configurations, each with distinctive properties. A particular configuration chosen may depend on specific properties needed for a target application. These properties, which include among others, rate of convergence, mis-adjustment, tracking, and computational requirements, are evaluated and weighed against each other to determine the appropriate configuration for the target application.

Of particular interest when choosing an adaptive filter configuration for use in a non-stationary signal environment are the rate of convergence, the mis-adjustment and the tracking capability. Good tracking capability is generally a function of the convergence rate and mis-adjustment properties of a corresponding algorithm. However, these properties may be contradictory in nature, in that a higher convergence rate will typically result in a higher convergence error or mis-adjustment of the resulting filter.

A recursive least squares (RLS) algorithm is generally a good tool for the non-stationary signal environment due to its fast convergence rate and low level of mis-adjustment. A recursive least squares lattice (RLSL) algorithm is one particular version of the RLS algorithm. The initial RLSL algorithm was introduced by Simon Haykin, and can be found in the “Adaptive Filter Theory Third Edition” book. The RLS class of adaptive filters exhibit fast convergence rates and are relatively insensitive to variations in an eigenvalue spread. Eigenvalues are a measure of correlation properties of the reference signal and the eigenvalue spread is typically defined as a ratio of the highest eigenvalue to the lowest eigenvalue. A large eigenvalue spread significantly slows down the rate of convergence for most adaptive algorithms.

However, the RLS algorithm typically requires extensive computational resources and can be prohibitive for embedded systems. Accordingly, there is a need to provide a mechanism by which the computational requirements of a RLSL adaptive filter are reduced.

### BRIEF DESCRIPTION OF THE DRAWINGS

FIGS. 1a-1d illustrate four schematic diagrams of applications employing an adaptive filter;

FIG. 2 is a block diagram of a RLSL structure adaptive filter;

FIG. 3 is a block diagram of a backward reflection coefficient update of the adaptive filter of FIG. 2;

FIG. 4 is a block diagram of a forward reflection coefficient update of the adaptive filter of FIG. 2;

FIG. 5 is a block diagram of a backward reflection coefficient update approximation of the adaptive filter of FIG. 2;

FIG. 6 is a graph illustrating backward error prediction squares for fifty samples of an input signal;

FIG. 7 is a graph illustrating forward error prediction squares for fifty samples of the input signal;

FIG. 8 is a graph illustrating forward error prediction squares minus backward error prediction squares over fifty samples of the input signal;

FIG. 9 is a graph illustrating forward error prediction squares minus backward error prediction squares multiplied by conversion coefficients over fifty samples of the input signal;

FIG. 10 is a graph illustrating echo return loss enhancements (ERLE) of the adaptive filter of FIG. 2, computed for both reduced and full computations of the forward error predictions squares estimated from the backward error prediction squares; and

FIG. 11 is a block diagram of a communication device employing an adaptive filter.

Illustrative and exemplary embodiments of the invention are described in further detail below with reference to and in conjunction with the figures.

### DETAILED DESCRIPTION

By way of introduction only, a method for reducing a computational complexity of an m-stage adaptive filter is provided. The method includes determining a weighted sum of backward prediction error squares for stage m at time n, determining a conversion factor for stage m at time n, inverting the weighted sum of backward prediction error squares, and approximating a weighted sum of forward prediction error squares by combining the inverted weighted sum of backward prediction error squares with the conversion factor. The present invention is defined by the appended claims. This description addresses some aspects of the present embodiments and should not be used to limit the claims.

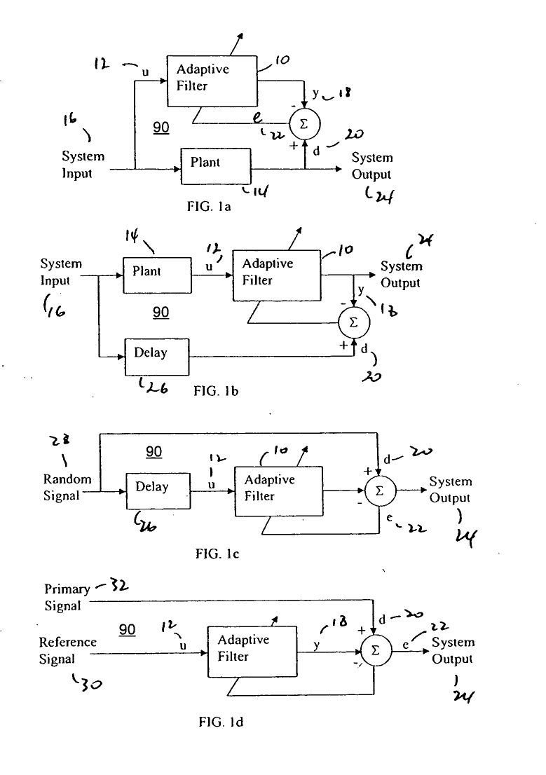

FIGS. 1a-1d illustrate four schematic diagrams of filter circuits 90 employing an adaptive filter 10. The filter circuits 90 in general and the adaptive filter 10 may be constructed in any suitable manner. In particular, the adaptive filter 10 may be formed using electrical components such as digital and analog integrated circuits. In other examples, the adaptive filter 10 is formed using a digital signal processor (DSP) operating in response to stored program code and data maintained in a memory. The DSP and memory may be integrated in a single component such as an integrated circuit, or may be maintained separately. Further, the DSP and memory may be components of another system, such as a speech processing system or a communication device.

In general, an input signal u(n) is supplied to the filter circuit 90 and to the adaptive filter 10. As shown, the adaptive filter 10 may be configured in a multitude of arrangements between a system input and a system output. It is intended that the improvements described herein may be applied to the widest variety of applications for the adaptive filter 10.

In FIG. 1a, an identification type application of the adaptive filter 10 is shown. In FIG. 1a, the filter circuit 90 includes an adaptive filter 10, a plant 14 and a summer. The plant 14 may be any suitable signal source being monitored. In this arrangement, the input signal u(n) received at an input 12 and is supplied to the adaptive filter 10 and to a signal processing plant 14 from a system input 16. A filtered signal y(n) 18 produced at an output by adaptive filter 10 is subtracted from a signal d(n) 20 supplied by plant 14 at an output to produce an error signal e(n) 22. The error signal e(n) 22 is fed back to the adaptive filter 10. In this identification type application, signal d(n) 20 also represents an output signal of the system output 24.

In FIG. 1b, an inverse modeling type application of the adaptive filter 10 is shown. In FIG. 1b, the filter circuit 90 includes an adaptive filter 10, a plant 14, a summer and a delay process 26. In this arrangement, an input signal originating from system input 16 is transformed into the input signal u(n) at the input 12 of the adaptive filter 10 by plant 14, and converted into signal d(n) 20 by the delay process 26. Filtered signal y(n) 18 of the adaptive filter 10 is subtracted from signal d(n) 20 to produce error signal e(n) 22, that is fed back to the adaptive filter 10.

In FIG. 1c, a prediction type application of the adaptive filter 10 is shown. In FIG. 1c, the filter circuit 90 includes an adaptive filter 10, a summer and a delay process 26. In this arrangement, adaptive filter 10 and delay process 26 are arranged in series between system input 16, now supplying a random signal input 28, and the system output 24. As shown, the random signal input 28 is subtracted as signal d(n) 20 from filtered signal y(n) 18 to produce error signal e(n) 22, that is fed back to the adaptive filter 10. In this prediction type application, error signal e(n) 22 also represents the output signal supplied by system output 24.

In FIG. 1d, an interference canceling type application of the adaptive filter 10 is shown. In FIG. 1d, the filter circuit 90 includes an adaptive filter 10 and a summer. In this arrangement, a reference signal 30 and a primary signal 32 are provided as input signal u(n) 12 and as signal d(n) 20, respectively. As shown, primary signal 32 is subtracted as signal d(n) 20 from filtered signal y(n) 18 to produce error signal e(n) 22, that is fed back to the adaptive filter 10. In this interference canceling type application, error signal e(n) 22 also represents the output signal supplied the system output 24.

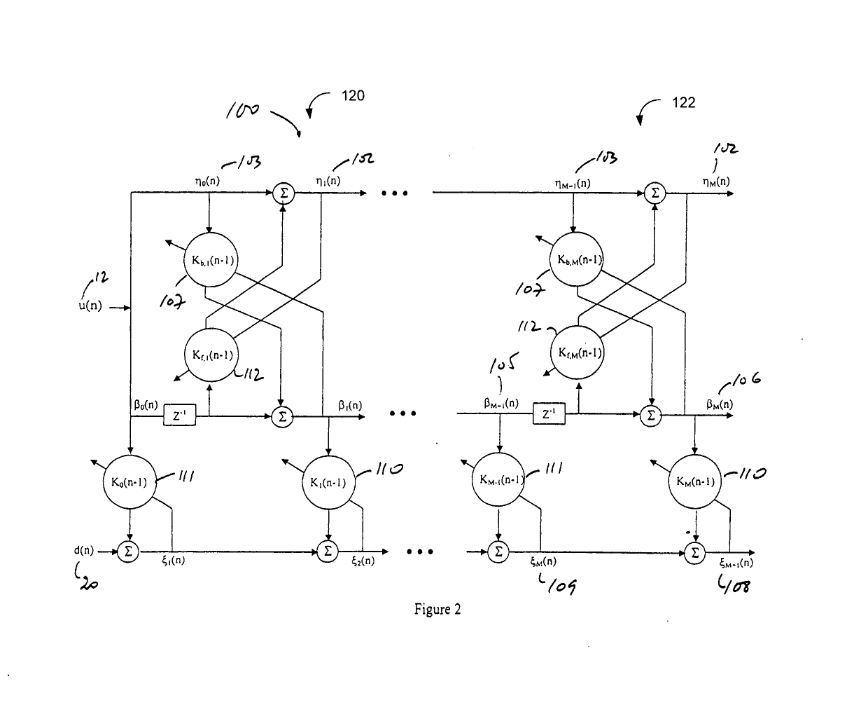

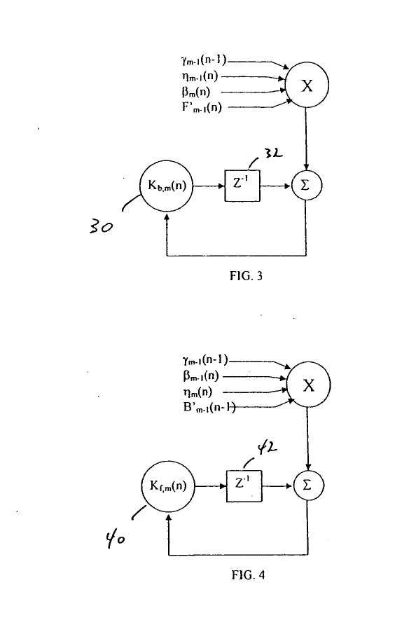

Now referring to FIG. 2, a block diagram of an m-stage RLSL adaptive filter 100 is shown. The adaptive filter 100 includes a plurality of stages including a first stage 120 and an m-th stage 122. Each stage (m) may be characterized by a forward prediction error ηₘ(n) 102, a forward prediction error ηₘ₋₁(n) 103, a forward reflection coefficient K_{ƒ,m-1}(n-1) 104, a delayed backward prediction error βₘ₋₁(n) 105, a backward prediction error β(n) 106, a backward reflection coefficient K_{b,m-1}(n-1) 107, an a priori estimation error backward ξₘ(n) 108, an a priori estimation error backward ξₘ₋₁ (n) 109 and a joint process regression coefficient Kₘ₋₁(n-1) 110. This m-stage adaptive RLSL filter 100 is shown with filter coefficients updates indicated by arrows drawn through each coefficient block. These filter coefficient updates are recursively computed for each stage (m) of a filter length of the RLSL filter 100 and for each sample time (n) of the input signal u(n) 12.

An RLSL algorithm for the RLSL filter 100 is defined below in terms of Equation 1 through Equation 8.

$$\begin{matrix}{F}_{m - 1} ( n ) = λ {F}_{m - 1} ( n - 1 ) + {γ}_{m - 1} ( n - 1 ) {\vert {η}_{m - 1} ( n ) \vert}^{2} & Equation 1 \\ {B}_{m - 1} ( n - 1 ) = λ {B}_{m - 1} ( n - 2 ) + {γ}_{m - 1} ( n - 1 ) {\vert {β}_{m - 1} ( n - 1 ) \vert}^{2} & Equation 1 \\ {η}_{m} ( n ) = {η}_{m - 1} ( n ) + {K}_{f , m} ( n - 1 ) {β}_{m - 1} ( n - 1 ) & Equation 2 \\ {β}_{m} ( n ) = {β}_{m - 1} ( n - 1 ) + {K}_{b , m} ( n - 1 ) {η}_{m - 1} ( n ) & Equation 3 \\ {K}_{f , m} ( n ) = {K}_{f , m} ( n - 1 ) - \frac{{γ}_{m - 1} ( n - 1 ) {β}_{m - 1} ( n - 1 )}{{B}_{m - 1} ( n - 1 )} {η}_{m} ( n ) & Equation 4 \\ {K}_{b , m} ( n ) = {K}_{b , m} ( n - 1 ) - \frac{{γ}_{m - 1} ( n - 1 ) {η}_{m - 1} ( n )}{{F}_{m - 1} ( n )} {β}_{m} ( n ) & Equation 5 \\ {γ}_{m} ( n - 1 ) = {γ}_{m - 1} ( n - 1 ) - \frac{{γ}_{m - 1}^{2} ( n - 1 ) {\vert {β}_{m - 1} ( n - 1 ) \vert}^{2}}{{B}_{m - 1} ( n - 1 )} & Equation 6 \\ {ξ}_{m} ( n ) = {ξ}_{m - 1} ( n ) - {K}_{m - 1} ( n - 1 ) {β}_{m - 1} ( n ) & Equation 7 \\ {K}_{m - 1} ( n ) = {K}_{m - 1} ( n - 1 ) + \frac{{γ}_{m - 1} ( n ) {β}_{m - 1} ( n )}{{B}_{m - 1} ( n )} {ξ}_{m} ( n ) & Equation 8\end{matrix}$$

The variables used in these equations are defined as follows:
Fₘ(n) Weighted sum of forward prediction error squares for stage m at time n.
Bₘ(n) Weighted sum of backward prediction error squares for stage m at time n.
ηₘ(n) Forward prediction error.
βₘ(n) Backward prediction error.
K_{b,m}(n) Backward reflection coefficient for stage m at time n.
K_{f,m}(n) Forward reflection coefficient for stage m at time n.
Kₘ(n) Joint process regression coefficient for stage m at time n.
γₘ(n) Conversion factor for stage m at time n.
ξₘ(n) A priori estimation error for stage m at time n.
λ A Exponential weighting factor or gain factor.

At stage zero, the RLSL filter 100 is supplied by signals u(n) 12 and d(n) 20. Subsequently, for each stage m, the above-defined filter coefficient updates are recursively computed. For example at stage m and time n, the forward prediction error ηₘ(n) 102 is the forward prediction error ηₘ₋₁(n) 103 of stage m-1 augmented by a combination of the forward reflection coefficient K_{f,m-1}(n-1) 104 with the delayed backward prediction error βₘ₋₁(n) 105.

In a similar fashion, at stage m and time n, the backward prediction error β(n) 106 is the backward prediction error βₘ₋₁(n) 105 of stage m-1 augmented by a combination of the backward reflection coefficient K_{b,m-1}(n-1) 107 with the delayed forward prediction error ηₘ₋₁(n) 103.

Moreover, the a priori estimation error backward ξₘ(n) 108, for stage m at time n, is the a priori estimation error backward ξₘ₋₁(n) 109 of stage m-1 reduced by a combination of the joint process regression coefficient K_{m-1/}(n-1) 110, of stage m-1 at time n-1, with the backward forward prediction error ξₘ₋₁(n) 105.

The adaptive filter 100 may be implemented using any suitable component or combination of components. In one embodiment, the adaptive filter is implemented using a DSP in combination with instructions and data stored in an associated memory. The DSP and memory may be part of any suitable system for speech processing or manipulation. The DSP and memory can be a stand-alone system or embedded in another system.

This RLSL algorithm requires extensive computational resources and can be prohibitive for embedded systems. As such, a mechanism for reducing the computational requirements of a RLSL structure adaptive filter 100 is obtained by approximating forward error prediction squares Fₘ(n) from backward error prediction squares Bₘ(n).

Typically, processors are substantially efficient at adding, subtracting and multiplying numbers, but not necessarily at dividing one number by another number. Most processors use a successive approximation technique to implement a divide instruction and may require multiple clock cycles to produce a result. As such, in an effort to reduce computational requirements, a total number of computations in the filter coefficient updates may need to be reduced as well as a number of divides that are required in the calculations of the filter coefficient updates. Thus, the RLSL algorithm filter coefficient updates are transformed to consolidate the divides. First, the time (n) and order (m) indices of the RLSL algorithm are translated to form Equation 9 through Equation 17.

$$\begin{matrix}{F}_{m} ( n ) = λ {F}_{m} ( n - 1 ) + {γ}_{m} ( n - 1 ) {\vert {η}_{m} ( n ) \vert}^{2} & Equation 9 \\ {B}_{m} ( n ) = λ {B}_{m} ( n - 1 ) + {γ}_{m} ( n ) {\vert {β}_{m} ( n ) \vert}^{2} & Equation 10 \\ {η}_{m} ( n ) = {η}_{m - 1} ( n ) + {K}_{f , m} ( n - 1 ) {β}_{m - 1} ( n - 1 ) & Equation 11 \\ {β}_{m} ( n ) = {β}_{m - 1} ( n - 1 ) + {K}_{b , m} ( n - 1 ) {β}_{m - 1} ( n - 1 ) & Equation 12 \\ {K}_{f , m} ( n ) = {K}_{f , m} ( n - 1 ) - \frac{{γ}_{m - 1} ( n - 1 ) {β}_{m - 1} ( n - 1 )}{{B}_{m - 1} ( n - 1 )} {η}_{m} ( n ) & Equation 13 \\ {K}_{b , m} ( n ) = {K}_{b , m} ( n - 1 ) - \frac{{γ}_{m - 1} ( n - 1 ) {η}_{m - 1} ( n )}{{F}_{m - 1} ( n )} {β}_{m} ( n ) & Equation 14 \\ {γ}_{m} ( n ) = {γ}_{m - 1} ( n ) - \frac{{γ}_{m - 1}^{2} ( n ) {\vert {β}_{m - 1} ( n ) \vert}^{2}}{{B}_{m - 1} ( n )} & Equation 15 \\ {ξ}_{m} ( n ) = {ξ}_{m - 1} ( n ) - {K}_{m - 1} ( n - 1 ) {β}_{m - 1} ( n ) & Equation 16 \\ {K}_{m} ( n ) = {K}_{m} ( n - 1 ) + \frac{{γ}_{m} ( n ) {β}_{m} ( n )}{{B}_{m} ( n )} {ξ}_{m + 1} ( n ) & Equation 17\end{matrix}$$

Then, the forward error prediction squares Fₘ(n) and the backward error prediction squares Bₘ(n) are inverted and redefined to be their reciprocals as shown in Equation 18, Equation 20 and Equation 21. Thus, by inverting Equation 9 we get:

$$\frac{1}{{F}_{m} ( n )} = \frac{1}{λ {F}_{m} ( n - 1 ) + {γ}_{m} ( n - 1 ) {\vert {η}_{m} ( n ) \vert}^{2}} \qquad Equation 18$$

Then redefine the forward error prediction squares Fₘ(n):

$${F}^{′} = \frac{1}{F} \qquad Equation 19$$

Then insert into Equation 18 and simplify:

$${F}_{m}^{′} ( n ) = \frac{1}{λ \frac{1}{{F}_{m}^{′} ( n - 1 )} + {γ}_{m} ( n - 1 ) {\vert {η}_{m} ( n ) \vert}^{2}} = \frac{{F}_{m}^{′} ( n - 1 )}{λ + {F}_{m}^{′} ( n - 1 ) {γ}_{m} ( n - 1 ) {\vert {η}_{m} ( n ) \vert}^{2}} \qquad Equation 20$$

By the same reasoning, the backwards error prediction squares, Equation 10, becomes

$${B}_{m}^{′} ( n ) = \frac{{B}_{m}^{′} ( n - 1 )}{λ + {B}_{m}^{′} ( n - 1 ) {λ}_{m} ( n ) {\vert {β}_{m} ( n ) \vert}^{2}} \qquad Equation 21$$

Further, new definitions for the forward and backward error prediction squares, F′ₘ(n) and B′ₘ(n), are inserted back into the remaining equations, Equation 13, Equation 14, Equation 15, and Equation 17, to produce the algorithm coefficient updates as shown below in Equation 22 through Equation 30.

$$\begin{matrix}{F}_{m}^{′} ( n ) = \frac{{F}_{m}^{′} ( n - 1 )}{λ + {F}_{m}^{′} ( n - 1 ) {γ}_{m} ( n - 1 ) {\vert {η}_{m} ( n ) \vert}^{2}} & Equation 22 \\ {B}_{m}^{′} ( n ) = \frac{{B}_{m}^{′} ( n - 1 )}{γ + {B}_{m}^{′} ( n - 1 ) {γ}_{m} ( n ) {\vert {β}_{m} ( n ) \vert}^{2}} & Equation 23 \\ {β}_{m} ( n ) = {β}_{m - 1} ( n - 1 ) + {K}_{b , m} ( n - 1 ) {η}_{m - 1} ( n ) & Equation 24 \\ {K}_{b , m} ( n ) = {K}_{b , m} ( n - 1 ) - {γ}_{m - 1} ( n - 1 ) {η}_{m - 1} ( n ) {β}_{m} ( n ) {F}_{m - 1}^{′} ( n ) & Equation 25 \\ {η}_{m} ( n ) = {η}_{m - 1} ( n ) + {K}_{f , m} ( n - 1 ) {β}_{m - 1} ( n - 1 ) & Equation 26 \\ {K}_{f , m} ( n ) = {K}_{f , m} ( n - 1 ) - {γ}_{m - 1} ( n - 1 ) {β}_{m - 1} ( n - 1 ) {η}_{m} ( n ) {B}_{m - 1}^{′} ( n - 1 ) & Equation 27 \\ {ξ}_{m} ( n ) = {ξ}_{m - 1} ( n ) - {K}_{m - 1} ( n - 1 ) {β}_{m - 1} ( n ) & Equation 28 \\ {K}_{m} ( n ) = {K}_{m} ( n - 1 ) + {γ}_{m} ( n ) {β}_{m} ( n ) {ξ}_{m + 1} ( n ) {B}_{m}^{′} ( n ) & Equation 29 \\ {γ}_{m} ( n ) = {γ}_{m - 1} ( n ) - {γ}_{m - 1}^{′} ( n ) {\vert {β}_{m - 1} ( n ) \vert}^{2} {B}_{m - 1}^{′} ( n ) & Equation 30\end{matrix}$$

Now, the forward error prediction squares F′ₘ(n) can be closely approximated from a combination of the backward error prediction squares B′ₘ(n) and the conversion factor yₘ(n) as shown below in Equation 31:
F′ₘ(n)≅B′ₘ(n)γₘ(n) Equation 31

Now referring to FIG. 3, a block diagram of the backward reflection coefficient update K_{b,m}(n) 30 as evaluated in Equation 25 is shown. The block diagram of FIG. 3 is representative of, for example, a digital signal processor operation or group of operations. The backward reflection coefficient update K_{b,m}(n) 30 is supplied to a delay 32 and the output of delay 32 K_{b,m}(n-1) is summed to a product of the forward error prediction squares F′ₘ(n) with the backward prediction error β(n), the forward prediction error ηₘ₋₁(n), and the conversion factor γₘ(n-1).

Now referring to FIG. 4, a block diagram of the forward reflection coefficient update K_{ƒb,m}(n) 40 as evaluated in Equation 28 is shown. Similar to FIG. 3, the block diagram of FIG. 4 is representative of, for example, a digital signal processor operation or group of operations. The forward reflection coefficient update K_{b,m}(n) 40 is supplied to a delay 42. The output of delay 42 K_{ƒ,m}(n-1) is summed to a product of the backward error prediction squares B′ₘ₋₁(n-1) with the backward prediction error βₘ₋₁(n), the forward prediction error ηₘ(n), and the conversion faction γₘ₋₁(n-1).

Now referring to FIG. 5, a block diagram of the forward reflection coefficient update K_{b,m}(n) 30 is shown. Similar to FIG. 3, the block diagram of FIG. 5 is representative of, for example, a DSP operation or group of operations. The forward reflection coefficient update K_{b,m}(n) 30 is approximated by substituting F′ₘ₋₁(n) with its approximation of the following product (B′ₘ₋₁(n)) (γₘ(n-1)), as shown above in equation 31.

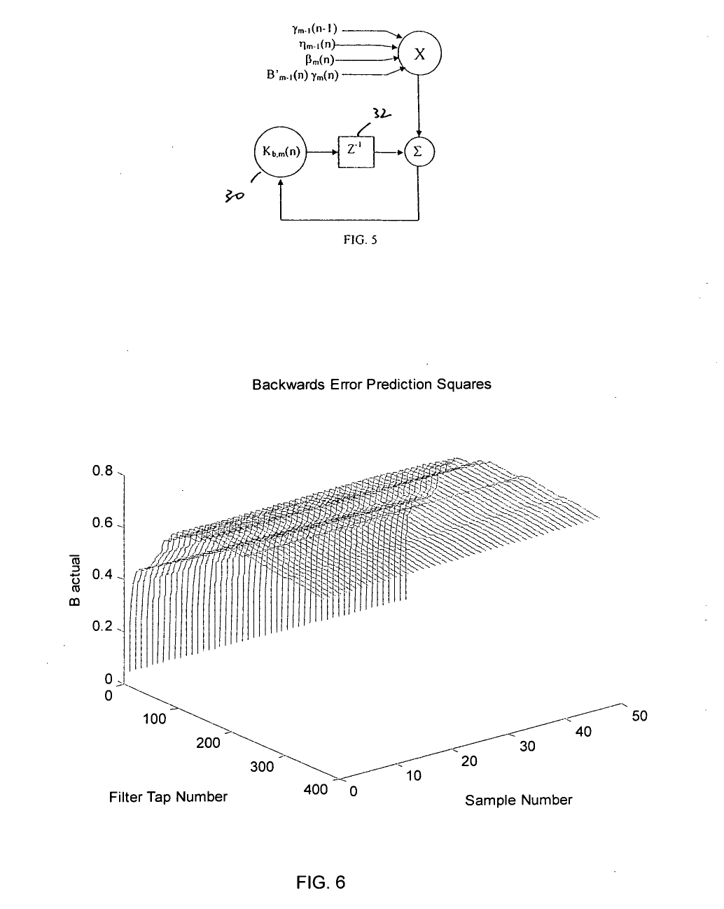

Now referring to FIGS. 6-10, these figures show the forward and backward error prediction squares, Fₘ(n) and Bₘ(n), and the difference between them during a period of high convergence of the adaptive filter RLSL filter 100.

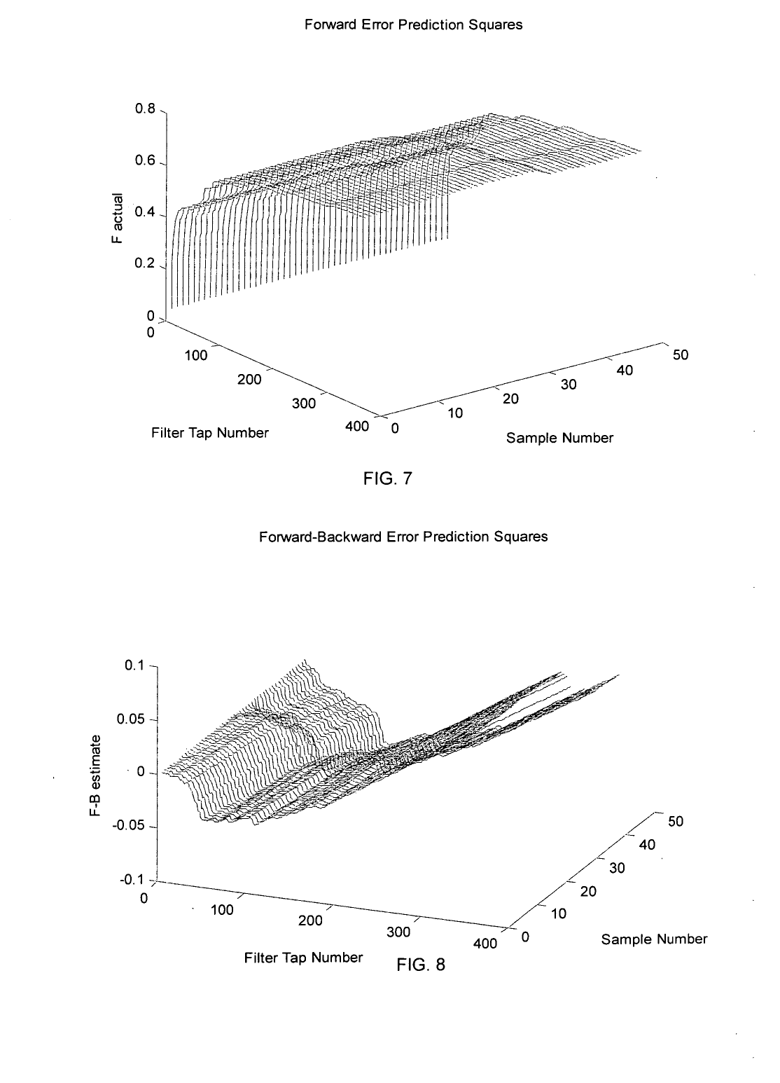

FIG. 6 shows a plot of the backward error prediction squares term Bₘ(n) versus the length of the filter (tap 1 to 400) for 50 samples of input signal u(n) 12. FIG. 7 shows a plot of the forward error prediction squares Fₘ(n) over the same input signal u(n) 12. By comparing the two plots, it becomes apparent that these two terms, Fₘ(n) and Bₘ(n), are substantially similar to each other in both shape and magnitude. This similarity between the two plots leads to a conclusion that one term can be approximated from the other term, thereby mitigating a need to perform the calculation of one of these two terms.

FIG. 8 shows a graph illustrating forward error prediction squares Fₘ(n) minus backward error prediction squares Bₘ(n), over fifty samples of the input signal u(n) 12. From FIG. 8, it appears that the difference between the two prediction terms is substantially large to use the backwards prediction error squares Bₘ(n) directly in estimating the forward prediction error squares Fₘ(n). However, when the conversion factor yₘ(n) is combined with the backwards prediction error Bₘ(n), as shown in Equation 31, then the error between the two error prediction squares Fₘ(n) and Bₘ(n) is minimized to a useful and acceptable level.

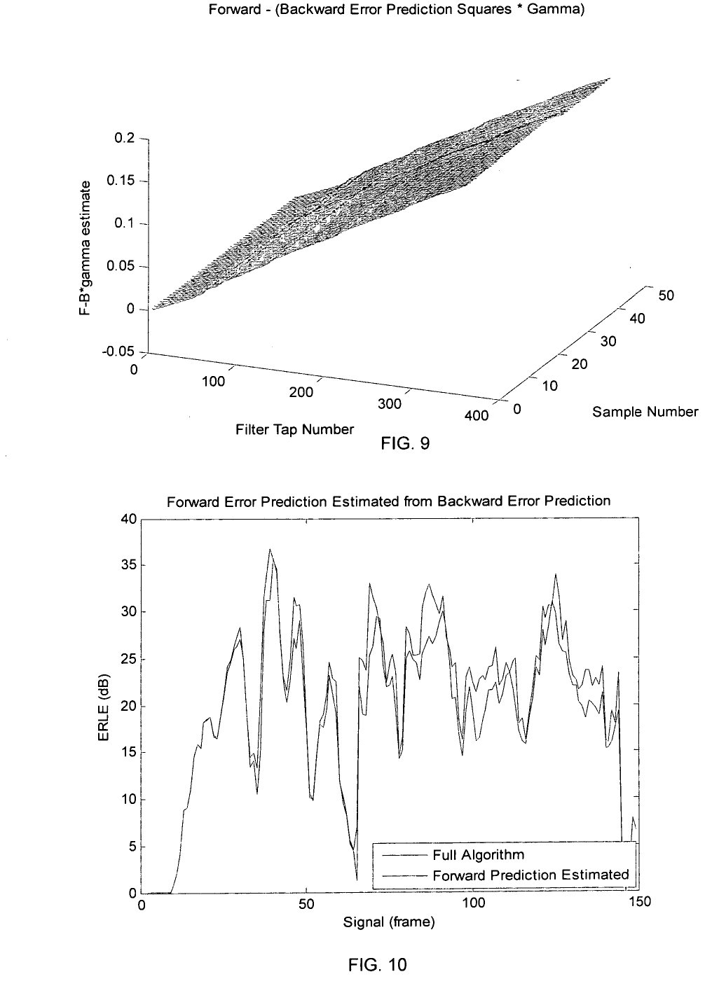

FIG. 9 shows the difference between the forward and backward error prediction squares, Fₘ(n) and Bₘ(n), after using yₘ(n) to modify the backward error prediction squares Bₘ(n). The resulting RLSL algorithm which uses the backward error prediction squares Bₘ(n) and yₘ(n) to estimate the forward error prediction squares Fₘ(n) is shown below in Equation 32 through Equation 39.

In the resulting embodiment implementing the RLSL algorithm, the forward error prediction squares Fₘ(n) are not calculated and an update to the backward reflection coefficient Bₘ(n), as shown Equation 34, uses the backward error prediction squares Bₘ(n) combined with γₘ(n) to estimate the update. This reduction in the number of calculations needed for the algorithm is substantially significant. Test results of embodiments using the reduced RLSL algorithm showed computational real-time savings up to 20 percent over embodiments using the full algorithm.

An echo return loss enhancement (ERLE) of the an adaptive filter in accordance with the reduced RLSL technique disclosed herein was measured for both the estimated results and the full results of the RLSL algorithm to verify that the performance of the adaptive filter 10 was not significantly degraded. The plots of these results are shown in FIG. 10. In practice, this is an acceptable performance for most applications and the reduction in computational requirements of the RLSL algorithm is valuable in applications employing the improved RLSL algorithm. The resulting RLSL filter algorithm using the estimated forward error prediction squares F′ₘ (n) may be characterized by Equation 32 to Equation 39. Of course, enhancements and modifications may be made to the filter algorithm disclosed herein.

$$\begin{matrix}{B}_{m}^{′} ( n ) = \frac{{B}_{m}^{′} ( n - 1 )}{λ + {B}_{m}^{′} ( n - 1 ) {γ}_{m} ( n ) {\vert {β}_{m} ( n ) \vert}^{2}} & Equation 32 \\ {β}_{m} ( n ) = {β}_{m - 1} ( n - 1 ) + {K}_{b , m} ( n - 1 ) {η}_{m - 1} ( n ) & Equation 33 \\ {K}_{b , m} ( n ) = {K}_{b , m} ( n - 1 ) - {γ}_{m - 1} ( n - 1 ) {η}_{m - 1} ( n ) {β}_{m} ( n ) {B}_{m}^{′} ( n ) {γ}_{m} ( n ) & Equation 34 \\ {η}_{m} ( n ) = {η}_{m - 1} ( n ) + {K}_{f , m} ( n - 1 ) {β}_{m - 1} ( n - 1 ) & Equation 35 \\ {K}_{f , m} ( n ) = {K}_{f , m} ( n - 1 ) - {γ}_{m - 1} ( n - 1 ) {β}_{m - 1} ( n - 1 ) {η}_{m} ( n ) {B}_{m}^{′} ( n - 1 ) & Equation 36 \\ {ξ}_{m} ( n ) = {ξ}_{m - 1} ( n ) - {K}_{m - 1} ( n - 1 ) {β}_{m - 1} ( n ) & Equation 37 \\ {K}_{m} ( n ) = {K}_{m} ( n - 1 ) + {γ}_{m} ( n ) {β}_{m} ( n ) {ξ}_{m + 1} ( n ) {B}_{m}^{′} ( n ) & Equation 38 \\ {γ}_{m} ( n ) = {γ}_{m - 1} ( n ) - {γ}_{m - 1}^{2} ( n ) {\vert {β}_{m - 1} ( n ) \vert}^{2} {B}_{m - 1}^{′} ( n ) & Equation 39\end{matrix}$$

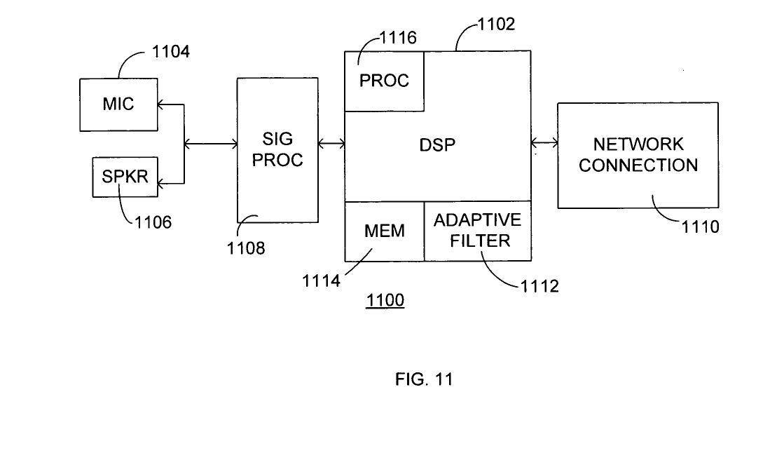

FIG. 11 is a block diagram of a communication device 1100 employing an adaptive filter. The communication device 1100 includes a DSP 1102, a microphone 1 104, a speaker 1106, an analog signal processor 1108 and a network connection 1110. The DSP 1102 may be any processing device including a commercially available DSP adapted to process audio and other information.

The communication device 1100 includes a microphone 1104 and speaker 1106 and analog signal processor 1108. The microphone 1104 converts sound waves impressed thereon to electrical signals. Conversely, the speaker 1106 converts electrical signals to audible sound waves. The analog signal processor 1108 serves as an interface between the DSP, which operates on digital data representative of the electrical signals, and the electrical signals useful to the microphone 1104 and 1106. In some embodiments, the analog signal processor 1108 may be integrated with the DSP 1102.

The network connection 1110 provides communication of data and other information between the communication device 1100 and other components. This communication may be over a wire line, over a wireless link, or a combination of the two. For example, the communication device 1100 may be embodied as a cellular telephone and the adaptive filter 1112 operates to process audio information for the user of the cellular telephone. In such an embodiment, the network connection 1110 is formed by the radio interface circuit that communicates with a remote base station. In another embodiment, the communication device 1100 is embodied as a hands-free, in-vehicle audio system and the adaptive filter 1112 is operative to serve as part of a double-talk detector of the system. In such an embodiment, the network connection 1110 is formed by a wire line connection over a communication bus of the vehicle.

In the embodiment of FIG. 11, the DSP 1102 includes data and instructions to implement an adaptive filter 1112, a memory 1114 for storing data and instructions and a processor 1116. The adaptive filter 1112 in this embodiment is an RLSL adaptive filter of the type generally described herein. In particular, the adaptive filter 1112 is enhanced to reduce the number of calculations required to implement the RLSL algorithm as described herein. The adaptive filter 1112 may include additional enhancements and capabilities beyond those expressly described herein. The processor 1116 operates in response to the data and instructions implementing the adaptive filter 1112 and other data and instructions stored in the memory 1114 to process audio and other information of the communication device 1100.

In operation, the adaptive filter 1112 receives an input signal from a source and provides a filtered signal as an output. In the illustrated embodiment, the DSP 1102 receives digital data from either the analog signal processor 1108 or the network interface 1110. The analog signal processor 1108 and the network interface 1110 thus form means for receiving an input signal. The digital data is representative of a time-varying signal and forms the input signal. As part of audio processing, the processor 1116 of DSP 1102 implements the adaptive filter 1112. The data forming the input signal is provided to the instructions and data forming the adaptive filter. The adaptive filter 1112 produces an output signal in the form of output data. The output data may be further processed by the DSP 1102 or passed to the analog signal processor 1108 or the network interface 1110 for further processing.

The communication device 1100 may be modified and adapted to other embodiments as well. The embodiments shown and described herein are intended to be exemplary only.

It is therefore intended that the foregoing detailed description be regarded as illustrative rather than limiting, and that it be understood that it is the following claims, including all equivalents, that are intended to define the spirit and scope of this invention.

1. A method for an adaptive filter, the method comprising:
receiving an input signal;
either estimating forward error prediction squares from backward error prediction squares for the filter, or estimating backward error prediction squares from the forward error prediction squares to eliminate calculation of both forward and reverse error prediction squares;
filtering the input signal using either the estimated forward error prediction squares or the estimated backward error prediction squares to produce a filtered signal; and
providing the filtered signal as an output signal.

2. The method of claim 1 wherein estimating forward error prediction squares comprises:
estimating forward error prediction squares F′ₘ(n) for the adaptive filter from a combination of the backward error prediction squares B′ₘ(n) and a conversion factor yₘ(n), where m corresponds to a filter stage and n corresponds to time.

3. The method of claim 2 wherein the conversion factor yₘ(n) comprises an exponential weighting factor based on the backward prediction error and a weighted sum of backward prediction error squares for stage m at time n.

4. A method for reducing computational complexity of an m-stage adaptive filter, the method comprising:
receiving an input signal;
determining a weighted sum of backward prediction error squares for stage m at time n;
determining a conversion factor for stage m at time n;
inverting the weighted sum of backward prediction error squares;
approximating a weighted sum of forward prediction error squares by combining the inverted weighted sum of backward prediction error squares with the conversion factor;
filtering the received input signal in accordance with the approximated weighted sum to produce a filtered signal; and
providing the filtered signal as an output signal.

5. The method of claim 4 wherein determining a conversion factor comprises forming an exponential weighting factor based on a backward prediction error and a weighted sum of backward prediction error squares for stage m at time n.

6. An m-stage adaptive filter comprising:
means for receiving an input signal;
means for determining a weighted sum of backward prediction error squares for stage m at time n;
means for determining a conversion factor for stage m at time n;
means for inverting the weighted sum of backward prediction error squares;
means for approximating a weighted sum of forward prediction error squares by combining the inverted weighted sum of backward prediction error squares with the conversion factor;
means for filtering the received input signal in accordance with the approximated weighted sum to produce a filtered signal; and
means for providing the filtered signal as an output signal.

7. An adaptive filter comprising:
an interface to receive an input signal;
a processor operative in conjunction with stored data and instructions to estimate forward error prediction squares from backward error prediction squares for the adaptive filter to reduce calculation of filter coefficients by the processor, and to filter the input signal using the estimated forward error prediction squares to produce a filtered signal; and
an interface to provide the filtered signal as an output signal.
